(19) United States
(12) Patent Application Publication
(10) Pub. No.: US 2023/0035551 A1
(43) Pub. Date: Feb. 2, 2023

(54) MULTIPLE SOURCE AUDIT LOG GENERATION

(71) Applicant: Intuit Inc., Mountain View, CA (US)

(72) Inventors: Shivang Bhadresh Shah, Newark, CA (US); Saharath Jay Jay Kleips, Sunnyvale, CA (US); Navjot Singh Cheema, Hayward, CA (US); Akbar Abdul Rangara, Austin, TX (US); Happy Bhairuprasad Somani, Fremont, CA (US); Jake Thomas Hilborn, Mountain View, CA (US)

(73) Assignee: Intuit Inc., Mountain View, CA (US)

(21) Appl. No.: 17/388,862

(22) Filed: Jul. 29, 2021

(51) Int. Cl. G06Q 20/38; G06Q 20/10; G06Q 30/04

(52) U.S. Cl. CPC G06Q 20/389; G06Q 20/102; G06Q 30/04

(57) ABSTRACT

Systems and methods for generating a multiple source audit log are disclosed. An example method includes receiving a first plurality of event messages from a first source, the first plurality of event messages respectively corresponding to a first plurality of events, receiving a second plurality of event messages from a second source, the second plurality of event messages respectively corresponding to a second plurality of events, identifying a first event of the first plurality of events and a second event of the second plurality of events for a first event of the plurality of events, the first event and the second event corresponding to a common transaction, and generating a first entry in an audit log corresponding to the common transaction based at least in part on a first message corresponding to the first event and a second message corresponding to the second event.

### TECHNICAL FIELD

This disclosure relates generally to generating audit logs, and more specifically to generating audit logs from messages generated by a plurality of data consumers.

### DESCRIPTION OF RELATED ART

Many companies and other entities store an enormous amount of valuable data in databases. While such data is valuable, the architectures of such databases may prevent their full value from being realized, for example, due to legacy databases' failure to sufficiently support data cleansing, organization, extraction of historical data, and real time streaming of cleansed data. This may significantly impact the value and ease of use of this data by downstream consumers. For example, a company may desire to leverage this stored data for use with artificial intelligence (AI) or machine learning (ML) applications to improve search functionality, to improve near real time data analytics, and so on. However, without being able to extract, cleanse, and stream such data, these downstream uses may not be possible, or may be unacceptably difficult. As such, there is a need for a system that can not only cleanse and stream data extracted from conventional databases but also forward messages associated with data changes in the database to downstream systems in a manner that ensures all messages relating to a particular event or transaction are received by the downstream systems concurrently.

Moreover, modern computing environments may include multiple data consumers, such as services, microservices, databases, and the like, each of which receives data from one or more applications. As such, users wishing to track and trace events occurring in these applications may need to analyze data processed by multiple data consumers.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for generating a multiple-source audit log. The method may be performed by a computing device, and may include receiving, from a first source, a plurality of first event messages corresponding to a plurality of first events. The method may include receiving, from a second source, a plurality of second event messages corresponding to a plurality of second events. The method may include identifying a pair of the first and second events associated with a common transaction based on a corresponding pair of the first and second event messages having a common identifier. The method may include generating a first entry in an audit log corresponding to the common transaction. In some implementations, the first event of the pair of first and second events corresponds to payment of an invoice, and the second event of the pair of first and second events corresponds to reception of the payment.

In various implementations, the first source and the second source are each one from the group consisting of a payroll service, a payment service, a database, and a microservice. In some instances, the common identifier may be an invoice number. In other instances, the common identifier may be an account number. In some other instances, the common identifier may be a unique identifier. In some aspects, the first entry is ordered in the audit log based on timestamps of the pair of first and second event messages. In other aspects, the first entry in the audit log specifies an event type of the common transaction.

In some implementations, the method may also include receiving, from a third source, a plurality of third event messages associated with a plurality of third events, determining that one of the third events and a second entry in the audit log correspond to a single transaction, and modifying the second entry in the audit log based at least in part on the third event message corresponding to the determined third event.

Another innovative aspect of the subject matter described in this disclosure can be implemented in a computing system. An example system includes one or more processors coupled to a memory. The memory stores instructions that, when executed by the one or more processors, causes the system to receive, from a first source, a plurality of first event messages corresponding to a plurality of first events and to receive, from a second source, a plurality of second event messages corresponding to a plurality of second events. Execution of the instructions may also cause the system to identify a pair of the first and second events associated with a common transaction based on a corresponding pair of the first and second event messages having a common identifier. Execution of the instructions may also cause the system to generate a first entry in an audit log corresponding to the common transaction. In some implementations, the first event of the pair of first and second events corresponds to payment of an invoice, and the second event of the pair of first and second events corresponds to reception of the payment.

In various implementations, the first source and the second source are each one from the group consisting of a payroll service, a payment service, a database, and a microservice. In some instances, the common identifier may be an invoice number. In other instances, the common identifier may be an account number. In some other instances, the common identifier may be a unique identifier. In some aspects, the first entry is ordered in the audit log based on timestamps of the pair of first and second event messages. In other aspects, the first entry in the audit log specifies an event type of the common transaction.

In some implementations, execution of the instructions may also cause the system to receive, from a third source, a plurality of third event messages associated with a plurality of third events, to determine that one of the third events and a second entry in the audit log correspond to a single transaction, and to modify the second entry in the audit log based at least in part on the third event message corresponding to the determined third event.

Another innovative aspect of the subject matter described in this disclosure can be implemented in a non-transitory computer-readable storage medium of a system including or coupled to a database. The non-transitory computer-readable storage medium stores instructions that, when executed by one or more processors of the system, causes the system to perform a number of operations. In some implementations, the operations may include receiving, from a first source, a plurality of first event messages corresponding to a plurality of first events. The operations may include receiving, from a second source, a plurality of second event messages corresponding to a plurality of second events. The operations may include identifying a pair of the first and second events associated with a common transaction based on a corresponding pair of the first and second event messages having a common identifier. The operations may include generating a first entry in an audit log corresponding to the common transaction. In some implementations, the first event of the pair of first and second events corresponds to payment of an invoice, and the second event of the pair of first and second events corresponds to reception of the payment.

In various implementations, the first source and the second source are each one from the group consisting of a payroll service, a payment service, a database, and a microservice. In some instances, the common identifier may be an invoice number. In other instances, the common identifier may be an account number. In some other instances, the common identifier may be a unique identifier. In some aspects, the first entry is ordered in the audit log based on timestamps of the pair of first and second event messages. In other aspects, the first entry in the audit log specifies an event type of the common transaction.

In some implementations, the operations may also include receiving, from a third source, a plurality of third event messages associated with a plurality of third events, determining that one of the third events and a second entry in the audit log correspond to a single transaction, and modifying the second entry in the audit log based at least in part on the third event message corresponding to the determined third event.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows an audit log generation system, according to some implementations.

FIG. 2 shows a high-level overview of an example process flow that may be employed by the audit log generation system of FIG. 1.

FIG. 3 shows a block diagram of an audit log generation system, according to some implementations.

FIG. 4 shows a block diagram of an audit log generation system, according to some implementations.

FIG. 5 shows an illustrative flow chart depicting an example operation for generating entries in an audit log, according to some implementations.

FIG. 6 shows an illustrative flow chart depicting another example operation for generating entries in an audit log, according to some implementations.

Like numbers reference like elements throughout the drawings and specification.

### DETAILED DESCRIPTION

Implementations of the subject matter described in this disclosure may be used to generate audit logs based on messages received from a plurality of sources, such as application services, microservices, databases, and so on. Such messages may relate to events occurring with respect to one or more applications. More specifically, messages received from two or more sources may correspond to the same event. For example, a first message from a first source may correspond to payment of an invoice, while a second message from a second source may correspond to reception of that payment. Aspects of the present disclosure may identify messages corresponding to the same event or transaction and group them when generating entries in the audit log. In some aspects, such messages may be identified based on the messages including a common identifier. Accurately grouping messages received from the multiple sources into appropriate entries in an audit log allows for a single log to be generated for all relevant events occurring with respect to the one or more applications, regardless of source. These and other aspects of the example implementations are discussed further below.

Various implementations of the subject matter disclosed herein provide one or more technical solutions to the technical problem of efficiently and accurately generating audit logs including entries for events which may be represented in messages received from multiple sources. Example implementations may receive event messages from multiple sources, and identify two or more messages corresponding to a common transaction, and generate an entry in the audit log corresponding to the common transaction based on the two or more messages. For example, two or more messages may be identified based on their each containing a common identifier. The common identifier may identify a business entity, a transaction, an event, an invoice, or similar. More specifically, various aspects of the present disclosure provide a unique computing solution to a unique computing problem that did not exist prior to electronic event streaming systems which process changes from one or more databases, through a plurality of sources. As such, implementations of the subject matter disclosed herein are not an abstract idea such as organizing human activity or a mental process that can be performed in the human mind.

Moreover, various aspects of the present disclosure effect an improvement in the technical field of efficiently and accurately recording events and transactions of a database. Generating entries in a single audit log based on event messages received from multiple data sources allows for a single audit log to be generated, rather than generating a log for each of the data sources, and further allows for accurate recording of events which may result in the generation of event messages from two or more data sources. Receiving event messages from multiple sources, identifying event messages corresponding to a common transaction, and generating an entry in the audit log corresponding to the common transaction cannot be performed in the human mind, much less using pen and paper. In addition, implementations of the subject matter disclosed herein are usable with a wide variety of computing applications, and do far more than merely create contractual relationships, hedge risks, mitigate settlement risks, and the like, and therefore cannot be considered a fundamental economic practice.

Many companies and other entities may use a variety of microservices, application services, databases, and so on to process data from one or more applications. Such microservices, application services, payroll services, payment services, inventory services, databases, and so on may be referred to as data sources or data services. Ensuring such application data can be analyzed, tracked, and audited may be particularly important for such complicated systems, in order to track and document changes to data in various tables and accounts relating to the applications. However, a given transaction or event may result in changes processed by two or more data sources, complicating the tracking and tracing of such transactions or events. For example, issuance of an invoice may be documented in a first message from a first data source, while payment of that same invoice may be documented in a second message from a second data source. Similarly, shipment of a company's inventory from a warehouse may be documented in a first message from a first data source, while reception of that same inventory at a retail store may be documented in a second message from a second data source. Grouping messages which relate to the same event or transaction simplifies tracing or auditing such events and transactions. It would therefore be desirable to generate entries in an audit log grouping messages from different data sources which relate to the same event or transaction.

Accordingly, aspects of the present disclosure provide methods and apparatus for extracting messages from two or more data sources, such as messages representing events and transactions. Such messages may reflect changes in tables of a database and may be associated with one or more databases coupled to the two or more data sources. Further, such extracted messages may be parsed into groups of messages, based on context, such as each message of a group including a common identifier, signifying that the messages in a group relate to the same event or transaction. The groups of messages may be used to generate entries in an audit log corresponding to the event or transaction. This grouping may ensure that all messages pertaining to a specific event, transaction, occurrence, etc., are documented in the same entry of the audit log, so that downstream users of the audit log have a more easily traceable and auditable account of the events or transactions.

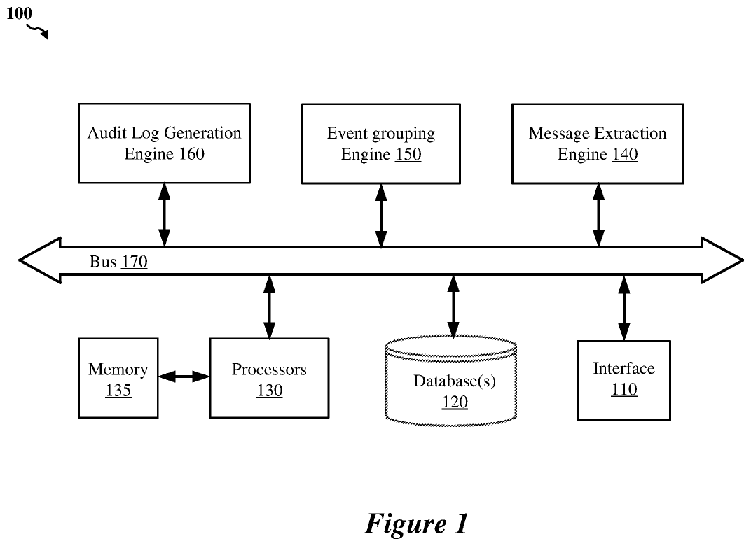

FIG. 1 shows an audit log generation system 100, according to some implementations. Various aspects of the audit log generation system 100 disclosed herein may be applicable for receiving event messages from a plurality of sources, identifying received messages corresponding to common events or transactions, and generating entries in a single audit log in a variety of computing applications. Such functionality may be useful for enabling the tracking, auditing, and other review and management of events occurring and recorded in a plurality of data sources, such as microservices, application services, databases, and so on. More particularly, an event or transaction may be reflected in messages from two or more sources, and documentation of such an event or transaction may be incomplete without an audit log entry reflecting all messages relating to and documenting that event or transaction.

The audit log generation system 100 is shown to include an input/output (I/O) interface 110, a database 120, one or more data processors 130, a memory 135 coupled to the data processors 130, a message extraction engine 140, event grouping engine 150, and an audit log generation engine 160. In some implementations, the various components of the audit log generation system 100 may be interconnected by at least a data bus 170, as depicted in the example of FIG. 1. In other implementations, the various components of the audit log generation system 100 may be interconnected using other suitable signal routing resources.

The interface 110 may include a screen, an input device, and other suitable elements that allow a user to provide information to the audit log generation system 100 and/or to retrieve information from the audit log generation system 100. Example information that can be provided to the audit log generation system 100 may include configuration information for the audit log generation system 100, such as information for configuring the message extraction engine 140, the event grouping engine 150, or the audit log generation engine 160. For example, information for configuring the message extraction engine 140 may include identification information for one or more databases and one or more data sources from which messages are to be extracted, message formatting information for the extracted messages, and so on. Configuration information for the event grouping engine 150 may include message formatting information for the one or more data sources, information for parsing extracted messages into groups, such as one or more common identifiers present in each message of a group. Configuration information for the audit log generation engine 160 may include formatting information for audit log entries, information relating to input and output access to one or more audit logs, and so on. Example information that can be retrieved from the audit log generation system 100 may include one or more audit log entries, one or more groups of audit log entries, configuration information for the audit log generation system 100, and the like.

The database 120, which may represent any suitable number of databases, may store any suitable information pertaining to configuration of the audit log generation system 100, may include information identifying one or more databases and one or more data sources from which messages are to be extracted and parsed by the audit log generation system 100, may include information pertaining to users of the audit log generation system 100, and so on. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120. In some aspects, the database 120 may include or be coupled to a QuickBooks Online (QBO) database, from Intuit, Inc. of Mountain View, Calif.

The data processors 130, which may be used for general data processing operations (such as manipulating the data sets stored in the database 120), may be one or more suitable processors capable of executing scripts or instructions of one or more software programs stored in the audit log generation system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The message extraction engine 140 may extract messages from one or more data sources included in or coupled to the audit log generation system 100, for example via the bus 170 or via one or more network interfaces. For example, the extracted messages may include a plurality of messages representing changes to tables of one or more databases and may be received from a plurality of data sources. In some aspects, the one or more data sources may include one or more application services, one or more microservices, or other sources of messages representing changes to the one or more databases.

The event grouping engine 150 may be used to parse extracted messages into groups, based on one or more common identifiers in the extracted messages. As discussed further below, the event grouping engine 150 may parse the extracted messages into groups of related messages based on the common identifiers, for example each group of messages may be related as pertaining to a common transaction, a common business entity, a common project, and so on. Identifying such common transactions, business entities, projects, and so on may correspond to identifying a common transaction identifier, such as an invoice or lot number, a business entity identifier such as a company name or account number, a project identifier, and so on. In some aspects, these identifiers may be unique identifiers, that is, identifiers which are not reused within the one or more applications.

The audit log generation engine 160 may generate entries in one or more audit logs based on information in the groups of messages. A single entry in an audit log may be generated based on information in two or more extracted messages grouped by the event grouping engine 150. For example, messages extracted from two or more data sources may be determined to correspond to a common transaction, business entity, or project and be grouped, and then the audit log generation engine 160 may generate a single entry in the audit log reflecting the common transaction, business entity, or project using information from the grouped messages. In some aspects the information in the two or more extracted messages grouped by the event grouping engine 150 may include one or more timestamps, and the generated audit log entry may be ordered based on such timestamps. Further, in some aspects the entry in the audit log may specify an event type of the common transaction, business entity, and so on. For example, the two or more grouped messages may relate to the issuance and payment of an invoice, and the generated entry in the audit log may indicate that the entry has an “invoicing” event type.

The particular architecture of the audit log generation system 100 shown in FIG. 1 is but one example of a variety of different architectures within which aspects of the present disclosure may be implemented. For example, in other implementations, the audit log generation system 100 may not include the message extraction engine 140, the functions of which may be implemented by the processors 130 executing corresponding instructions or scripts stored in the memory 135. In some other implementations, the functions of the event grouping engine 150 may be performed by the processors 130 executing corresponding instructions or scripts stored in the memory 135. Similarly, the functions of the audit log generation engine 160 may be performed by the processors 130 executing corresponding instructions or scripts stored in the memory 135.

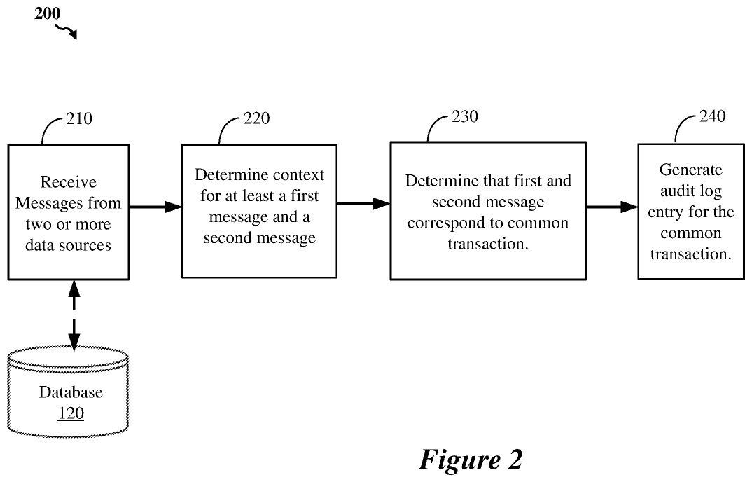

FIG. 2 shows a high-level overview of an example process flow 200 that may be employed by the audit log generation system 100 of FIG. 1. In block 210, the audit log generation system 100 receives a plurality of messages from two or more data sources, for example the messages may be received using the message extraction engine 140 via the interface 110. The messages may represent recent or real time events or transactions as recorded by the two or more data sources, where the data sources may each be a microservice, an application service, or other suitable services recording events, changes, or transactions associated with one or more applications or databases. In block 220, the audit log generation system 100 determines a context for at least a first message and a second message, the first message received from a first data source and the second message received from a second data source. For example, the event grouping engine 150 may determine the context of the first message and the second message using configuration data retrieved from the database 120 or received via one or more network interfaces coupled to the audit log generation system 100. In some examples, the context may be determined based on one or more identifiers in the first message and the second message. In block 230, the audit log generation system 100 may determine that the first and second messages correspond to a common transaction. For example, the event grouping engine 150 may group the first message and the second message based on the identified context of the messages. In some examples, the first message and the second message may be grouped based on each message including a common identifier, such as an identifier indicating a common transaction for each message in the group, a common business entity associated with each message in the group, a common purpose associated with each message in the group, and so on. In block 240, the audit log generation system 100 may generate an audit log entry for the common transaction. For example, the audit log generation engine 160 may generate the entry in the audit log.

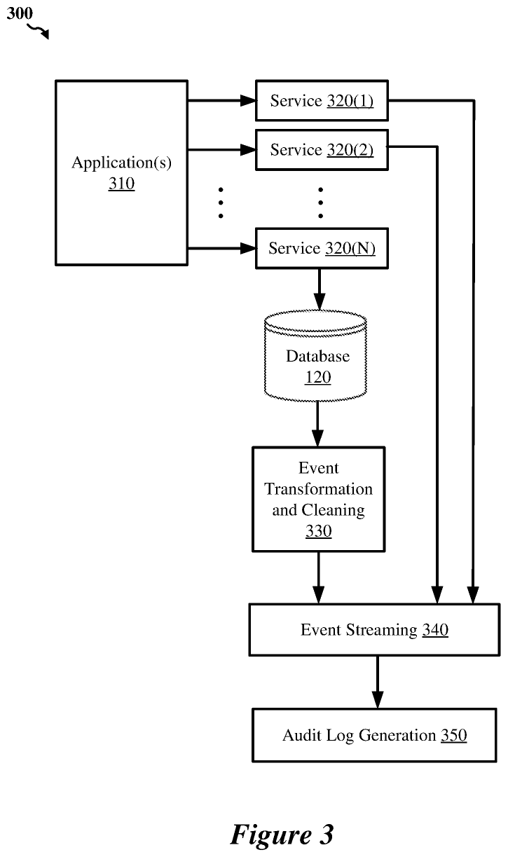

FIG. 3 shows a block diagram of an audit log generation system 300, according to some implementations. One or more applications 310 may be coupled to a plurality 320(1)-320(N) of services (collectively services 320). Each service of the services 320 may be a data source, such as a microservice, an application service, a database, and so on. Each service of the services 320 may perform operations using data from the applications 310. For example, the services 320 may obtain data from the applications 310 via one or more application user interfaces (not shown for simplicity). The services 320 may generate a plurality of messages each message corresponding to one or more of the performed operations. For some services, the generated messages may be provided to a database 120. The messages provided to the database 120 may then optionally be extracted by event transformation and cleaning 330. The event transformation and cleaning 330 may extract messages from the database 120, parse the extracted messages into groups of messages sharing a common identifier, and forward the groups of messages to the event streaming platform 340. Event streaming platform 340 may be any suitable event streaming platform, such as Apache Kafka. In some other aspects, messages generated by services of the services 320 may be provided directly to the event streaming platform 340. Note that while FIG. 3 shows the services 320 providing the messages to the event streaming platform 340, that in some other aspects, the event streaming platform 340 may be omitted. The messages generated by the services 320, and optionally the groups of messages from the event transformation and cleaning 330, may then be provided to audit log generation 350. Audit log generation 350 may be one example of the audit log generation system 100 of FIG. 1. Audit log generation 350 generates entries in an audit log corresponding to groups of one or more received messages, based on a determination that each message in a group corresponds to a common event or transaction. Entries in the audit log are thereby generated to include information from relevant messages from the services 320.

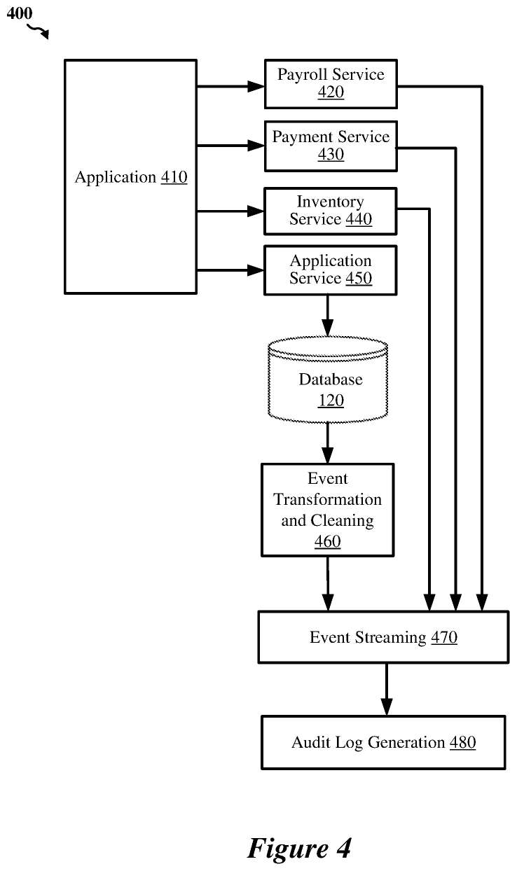

FIG. 4 shows a block diagram of an audit log generation system 400, according to some implementations. The audit log generation system 400 may be one example of the audit log generation system 300 of FIG. 3. The performed by any suitable system or apparatus, such as the audit log generation system 100 of FIG. 1. An application 410 may be coupled to a plurality of services, including a payroll service 420, a payment service 430, an inventory service 440, and an application service 450. The application 410 may be any suitable application, and may be, for example, a QuickBooks Online application from Intuit, Inc. of Mountain View, Calif. Note that while FIG. 4 shows four services processing data from the application 410 that other implementations may include greater or fewer numbers of services. The payroll service 420 may generate messages corresponding to individual or companywide payment of wages, benefits, deductions, and other operations for employees of a company. The payment service 430 may generate messages associated with payment of invoices, bills, and other expenses of the company. The inventory service 440 may generate messages associated with tracking of inventory and other assets and products of the company. The application service 450 may generate messages associated with various steps taken in operations of the company.

For example, the application service 450 may generate messages associated with adjusting customer account balances and other account balances of the company related to reception of payments. As with FIG. 3, the payroll service 420, payment service 430, inventory service 440, and application service 450 may obtain data from the database 410 via one or more application user interfaces (not shown for simplicity). For some services, such as the application service 450, the generated messages may be provided to a database 120. The provided messages may then be extracted by event transformation and cleaning 460.

The event transformation and cleaning 460 may extract messages from the database 120, parse the extracted messages into groups of messages sharing a common identifier, and forward the groups of messages to the event streaming platform 470. For example, the event transformation and cleaning 460 may receive one or more messages associated with a reception of a payment of an invoice from a customer and an adjustment of that customer's account balance, and group these two messages as relating to the same invoice. Event streaming platform 470 may be any suitable event streaming platform, such as Apache Kafka. In some aspects, messages generated by the payroll service 420, payment service 430, and inventory service 440 may be provided directly to the event streaming platform 470. The messages generated by the payroll service 420, payment service 430, inventory service 440, and the event transformation and cleaning 330 may then be provided to audit log generation 480. Audit log generation 480 may be one example of the audit log generation system 100 of FIG. 1. Audit log generation 480 generates entries in an audit log corresponding to groups of one or more received messages, based on a determination that each message in a group corresponds to a common event or transaction. In some aspects, after generating an entry in the audit log, one or more additional messages may be received from the one of the services 420-450 corresponding to the generated entry. For example, an entry may be generated relating to a particular invoice, and subsequently another message may be received relating to that invoice. In some aspects, the previously generated entry in the audit log may be amended to include information from the subsequently received message. Thus, entries in the audit log are generated to include information from relevant messages from the payroll service 420, the payment service 430, the inventory service 440, and the application service 450.

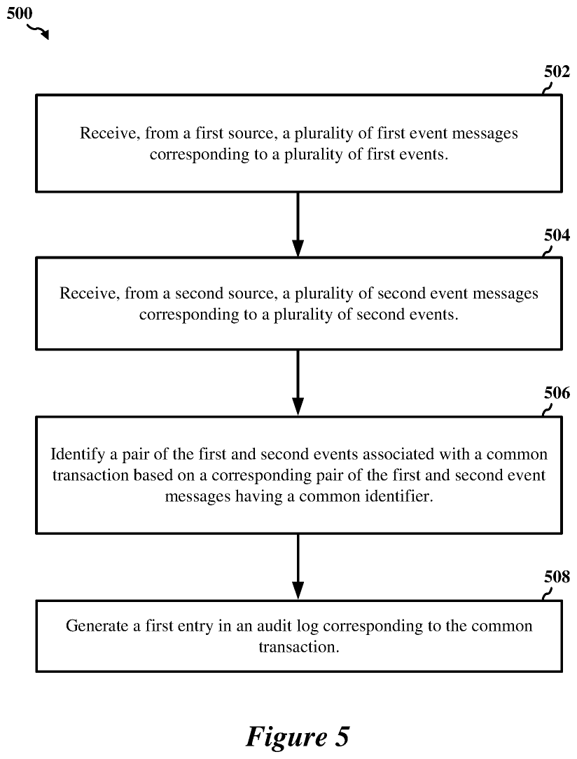

FIG. 5 shows an illustrative flow chart depicting an example operation 500 for generating entries in an audit log based on messages received from multiple data sources. The example operation 500 may be performed by one or more processors of a computing device such as the audit log generation system 100 of FIG. 1. In other implementations, the example operation 500 may be performed by any suitable systems, computers, or servers.

At block 502, the audit log generation system 100 receives, from a first source, a plurality of first event messages corresponding to a plurality of first events. At block 504, the audit log generation system 100 receives, from a second source, a plurality of second event messages corresponding to a plurality of second events. At block 506, the audit log generation system 100 identifies a pair of the first and second events associated with a common transaction based on a corresponding pair of the first and second event messages having a common identifier. At block 508, the audit log generation system 100 generates a first entry in an audit log corresponding to the common transaction. In some aspects, the first event of the pair of first and second events corresponds to payment of an invoice, and the second event of the pair of first and second events corresponds to reception of the payment.

In some implementations, the first source and the second source are each one from the group consisting of a payroll service, a payment service, a database, and a microservice. In some instances, the common identifier may be an invoice number. In other instances, the common identifier may be an account number. In some other instances, the common identifier may be a unique identifier. In some aspects, the first entry is ordered in the audit log based on timestamps of the pair of first and second event messages. In other aspects, the first entry in the audit log specifies an event type of the common transaction.

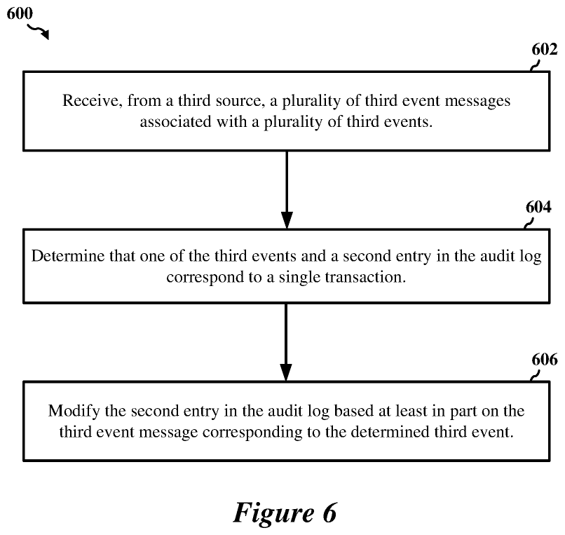

FIG. 6 shows an illustrative flow chart depicting an example operation 600 for parsing and publishing messages corresponding to changes in a database, according to some implementations. The example operation 600 may be performed by one or more processors of a computing device including or associated with the database, such as the message parsing and forwarding system 100 of FIG. 1. In other implementations, the example operation 600 may be performed by any suitable systems, computers, or servers.

In some implementations, the operation 600 may be performed after the example operation 600 described with reference to FIG. 5. For example, at block 602, the audit log generation system 100 receives, from a third source, a plurality of third event messages associated with a plurality of third events. At block 604, the audit log generation system 100 determines that one of the third events and a second entry in the audit log correspond to a single transaction. At block 604, the audit log generation system 100 modifies the second entry in the audit log based at least in part on the third event message corresponding to the determined third event.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

1. A method of generating a multiple-source audit log, comprising:
receiving, from a first source, a plurality of first event messages corresponding to a plurality of first events;
receiving, from a second source, a plurality of second event messages corresponding to a plurality of second events, wherein the first source and the second source are each one from the group consisting of a payroll service, a payment service, a database, and a microservice;
identifying a pair of the first and second events associated with a common transaction based on a corresponding pair of the first and second event messages having a common identifier;
generating a first entry in an audit log corresponding to the common transaction;
receiving, from a third source, a plurality of third event messages associated with a plurality of third events;
determining that one of the third events and the first entry in the audit log correspond to a single transaction; and
modifying the first entry in the audit log based at least in part on the third event message corresponding to the determined one of the third events.

2. The method of claim 1, wherein the common identifier comprises an invoice number.

3. The method of claim 1, wherein the common identifier comprises an account number.

4. The method of claim 1, wherein the common identifier comprises a unique identifier.

5. The method of claim 1, wherein the first event of the pair of first and second events corresponds to payment of an invoice, and the second event of the pair of first and second events corresponds to reception of the payment.

6. The method of claim 1, wherein the first entry is ordered in the audit log based on timestamps of the pair of first and second event messages.

7. The method of claim 1, wherein the first entry in the audit log specifies an event type of the common transaction.

8. (canceled)

9. (canceled)

10. A computing system, comprising:
one or more processors; and
a memory coupled to the one or more processors, the memory storing instructions that, when executed by the one or more processors, cause the computing system to:
receive, from a first source, a plurality of first event messages corresponding to a plurality of first events;
receive, from a second source, a plurality of second event messages corresponding to a plurality of second events, wherein the first source and the second source are each one from the group consisting of a payroll service, a payment service, a database, and a microservice;
identify a pair of the first and second events associated with a common transaction based on a corresponding pair of the first and second event messages having a common identifier;
generate a first entry in an audit log corresponding to the common transaction based on the corresponding pair of first and second event messages;
receiving, from a third source, a plurality of third event messages associated with a plurality of third events;
determining that one of the third events and the first entry in the audit log correspond to a single transaction; and
modifying the first entry in the audit log based at least in part on the third event message corresponding to the determined one of the third events.

11. The computing system of claim 10, wherein the common identifier comprises an invoice number.

12. The computing system of claim 10, wherein the common identifier comprises an account number.

13. The computing system of claim 10, wherein the common identifier comprises a unique identifier.

14. The computing system of claim 10, wherein the first event of the pair of first and second events corresponds to payment of an invoice, and the second event of the pair of first and second events corresponds to reception of the payment.

15. The computing system of claim 10, wherein the first entry is ordered in the audit log based on timestamps of the pair of first and second event messages.

16. The computing system of claim 10, wherein the first entry in the audit log specifies an event type of the common transaction.

17. (canceled)

18. (canceled)

19. A non-transitory computer-readable storage medium storing instructions for execution by one or more processors of a computing device, wherein execution of the instructions causes the computing device to perform operations comprising:
receiving, from a first source, a plurality of first event messages corresponding to a plurality of first events;
receiving, from a second source, a plurality of second event messages corresponding to a plurality of second events, wherein the first source and the second source are each one from the group consisting of a payroll service, a payment service, a database, and a microservice;
identifying a pair of the first and second events associated with a common transaction based on a corresponding pair of the first and second event messages having a common identifier;
generating a first entry in an audit log corresponding to the common transaction based on the corresponding pair of first and second event messages;
receiving, from a third source, a plurality of third event messages associated with a plurality of third events;
determining that one of the third events and the first entry in the audit log correspond to a single transaction; and
modifying the first entry in the audit log based at least in part on the third event message corresponding to the determined one of the third events.

20. (canceled)
